(19) United States
(12) Patent Application Publication
(10) Pub. No.: US 2007/0151048 A1
(43) Pub. Date: Jul. 5, 2007

(54) Use of polymeric etheramines for improving the chlorine fastness of textiles

(76) Inventors: Francis Palacin, Riedisheim (FR); Qian Tang, Oberwil (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/585,103

(22) PCT Filed: Dec. 23, 2004
(86) PCT No.: PCT/IB04/04288

§ 371 Date: Jun. 29, 2006

(30) Foreign Application Priority Data
Dec. 29, 2003 (EP) 03029908.5

(51) Int. Cl. C09B 67/00

(52) U.S. Cl. 8/602

(57) ABSTRACT

The use of polymeric etheramines (P) as aftertreatment agents for dyeings or colour prints obtained with at least one water soluble dye (F) on textile fibrous material (T), especially for improving their fastness to chlorine, the process for producing the aftertreated dyeings and colour prints, and particular aftertreatment compositions, as defined in the Claims.

The invention relates to the aftertreatment of textile dyeings or colour prints produced with water soluble dyes, with certain polymeric etheramines, in particular in order to improve their fastness to chlorine.

In order to meet the demand of the market and fashion in the textile field, textile goods are largely produced in dyed or colour-printed form, with dyes suiting the particular kind of substrate. Thus textile substrates dyeable with water soluble dyes—mainly cellulosic, polyamidic and tinctorially related substrates—may be dyed with various categories of water soluble dyes. Some main categories of water soluble dyes for these substrates are anionic dyes and cationic dyes, in particular of the categories of fibre reactive dyes, direct dyes, acid dyes, basic dyes, vat dyes and sulphur dyes. Depending on the selected substrates, dyes and dyeing or printing conditions, with a view to the desired colouristic effect, the dyeings and prints may display various fastness properties, which may vary broadly and, depending on the particular use and need, sometimes even be insufficient. Increasing requirements are more and more set on the various fastnesses, depending on the particular use to which the dyed or printed material is destined, and thus a particular problem in this field of the art is to find means for improving certain fastnesses of the dyeings and prints. A means for obviating this problem is in the treatment of such dyeings or prints with fixatives suitable for improving certain fastnesses of the dyeings and prints. From U.S. Pat. Nos. 4,599,087, 4,718,918 and 4,737,576 it is known e.g. to improve certain wet fastness properties of such dyeings and prints by aftertreating them with polycondensates of defined oligoamines with epichlorohydrin. GB patent 1114036 describes the aftertreatment of dyeings produced with sulphur dyes with condensates of certain mono- or oligoamines with epichlorohydrin in order to improve the wet fastness of the sulphur dyeings. A number of further documents relate to the improvement of certain wet fastness properties of such dyeings and colour prints by aftertreating them with condensates of oligoamines with cyanamide, dicyandiamide, guanidine or biguanide and in some cases with further reactants. Thus U.S. Pat. Nos. 4,410,652 and 4,452,606 describe the aftertreatment with condensates of oligoamines with cyanamide, dicyandiamide, guanidine or biguanide and with resin-forming methylol derivatives of certain amidic compounds e.g. urea, melamine or urone. U.S. Pat. No. 4,439,203 describes the aftertreatment with condensates of oligoamines with dicyandiamide further reacted either with epichlorohydrin or with formaldehyde alone or formaldehyde and a dihydroxyalkyleneurea or a dimethylether thereof. U.S. Pat. No. 4,764,585 describes an improvement of the aftertreatment according to U.S. Pat. Nos. 4,410,652 and 4,439,203 by using defined catalysts for the condensation of the oligoamines with cyanamide, dicyandiamide, guanidine or biguanide. U.S. Pat. No. 2,649,354 describes the aftertreatment of dyeings produced with direct dyes, with condensates of oligoamines with cyanamide or dicyandiamide. These wet fastness improvements, to which all these documents refer, are mainly in various fastnesses to water and to washing, but for U.S. Pat. No. 4,737,576 which mentions fastness to perspiration and to washing.

A particular problem in this field of the art is, however, the fastness to chlorine, i.e. the fastness of the dyeings or colour prints to the deleterious action of chlorine, as may occur as active chlorine in the water with which the dyed or printed textiles come into contact, e.g. in chlorinated water used in swimming pools, in household (used e.g. in laundry) or in industry, where the active chlorine is used e.g. as a germicide, and further as occurring when bleaching in aqueous solutions of potassium or sodium hypochlorite (e.g. as known in the art as Eau De Javelle or Eau De Labarraque). As is known in the art, and as described also e.g. in the article of T. Fujita and T. Tamiya “Improvement of the fastness to chlorinated water of reactive dyeings” in Senshoku Kogyo (1982), 30(5), 246-254, fixing agents usually do not have an improving effect on the fastness to chlorine, and may sometimes even deteriorate the fastness of reactive dyeings to chlorine, in particular those fixing agents which improve wet fastness, and which belong mainly to the category of polymers of the dicyandiamide condensate type and to the quaternary ammonium salt type. Textile dyeings and prints produced with water soluble dyes, e.g. with anionic or cationic dyes, such as basic dyes, acid dyes, mordant dyes, vat dyes, sulphur dyes, direct dyes or fibre reactive dyes, may be particularly subject to the impairing effect of chlorine, even if they have been aftertreated according to the processes described in the above patents.

In U.S. Pat. No. 4,410,652, which comprises an additional resin finish, the possibility of improving the fastness properties of fixed reactive dyes to chlorine is also mentioned, the resin finish has however, to a certain degree, a modifying effect on the handle of the textile.

U.S. Pat. No. 4,424,061 describes an aftertreatment of coloured cotton textiles with certain diamines in combination with a hydrolyzable tannin, in which an improvement of the fastness to chlorine may be achieved, while the tannin has a certain darkening effect on the dyeing. The aftertreatment with the defined amine alone is also described, but—as results e.g. from the measured values illustrated in the tables on dyeings with reactive dyes or a direct dye—leads to a less pronounced improvement of the fastness to chlorine, especially at higher chlorine concentrations or on a dyeing produced with a direct dye.

In JP 61 132691 A2 there is described the aftertreatment of dyeings with an oligomeric amide from dicarboxylic acid and a diamine, e.g. maleic acid anhydride and ethylene diamine, for improving the chlorine fastness of reactive dyeings. These products are applied by padding, as they are not particularly substantive, which reflects in their low resistance to repeated washing treatments.

It is thus also desired to achieve a chlorine fastness improvement of textile dyeings and colour prints in which the own characteristic shade and brilliance properties of the dyeing or print and the handle properties of the textile substrate are maintained to a high degree, while providing satisfactory stability of the fastness improving aftertreatment to repeated washing.

It has now surprisingly been found that by aftertreating these dyeings or colour prints with certain polymeric etheramines (P) defined below, there may be achieved an outstanding improvement of the fastness to chlorine of the defined dyeings and prints and of its resistance to washing, while the characteristic shade and brilliance of the dyeing and, especially when applied by exhaust methods, also the characteristic handle of the particular treated textile is substantially maintained.

The invention relates to the use of the defined polymeric etheramines as aftertreatment agents for the defined textile dyeings and colour prints, in particular for improving the fastness to chlorine, and respectively to the process for producing the aftertreated dyeings and prints, and further to particular aftertreatment agents and compositions and their use.

The invention thus firstly provides the use of a polymeric etheramine (P) obtainable by condensation reaction of a chloroterminated adduct (E) of
(A) an oligohydroxycompound with x hydroxy groups per molecule linked to a hydrocarbon radical optionally interrupted by oxygen, wherein x is a number in the range of 2 to 6,
   or a mixture of two or more thereof,
with
(B) epichlorohydrin,
in the ratio of m moles of epichlorohydrin for every mole of oligohydroxycompound (A), in which m is ≧2 and at most 1.2·x,
   with
(C) at least one amino compound containing in its basic form at least two reactive hydrogen atoms bonded to nitrogen and no tertiary amino groups,
   and optionally
(D) at least one aliphatic secondary monoamine and/or at least one aliphatic diamine containing a primary or secondary amino group and a tertiary amino group,
   or dehydrochlorination reaction of (E) to the corresponding epoxide (E_{X}) and reaction of (E_{X}) with (C) and optionally (D),
   and which is optionally protonated,
   as an aftertreatment agent for (T_{F}) dyeings or prints obtained with at least one water soluble dye (F) on textile fibrous material (T).

The polymeric products (P) may be produced by addition, dehydrochlorination and/or condensation reactions conventional per se. In particular, the process for the production of the polymeric optionally protonated etheramines (P) is characterised in that the chloroterminated reaction product (E) of (A) with (B) is reacted in aqueous medium with (C) and optionally (D) and the product is optionally protonated, preferably to a pH<6. According to a variant of this process, (E) is dehydrochlorinated to (E_{X}) and this is then reacted with (C) and optionally (D). The product (P) may thus be obtained in the form of an aqueous composition, and if desired the obtained aqueous composition may be dried.

As oligohydroxycompounds (A) there may be employed known compounds, in particular where the x hydroxy groups are linked to a low molecular hydrocarbon radical, preferably a saturated aliphatic hydrocarbon radical, especially with 2 to 6 carbon atoms, the number of hydroxy groups being ≦ the number of carbon atoms in this hydrocarbon radical, or are linked to an araliphatic radical, or to an aliphatic preferably saturated hydrocarbon radical interrupted by one or more oxygen atoms to form a mono- or polyether chain in which the single hydrocarbon radicals between two oxygen atoms are low molecular, preferably with 2 or 3 carbon atoms.

As araliphatic compounds (A) there may e.g. be mentioned known bisphenols, e.g. Bisphenol-F i.e. 4,4′-dihydroxydiphenylmethane and Bisphenol-A i.e. 2,2-bis-(4-hydroxyphenyl)-propane.

Preferred oligohydroxycompounds (A) may be represented by the following general formula
X—(OH)ₓ (I),
wherein x is a number in the range of 2 to 6
and X is the x-valent radical of a saturated aliphatic hydrocarbon with 2 to 6 carbon atoms or—where x is 2—also of a saturated aliphatic hydrocarbon interrupted by one or more oxygen atoms to form a mono- or polyether chain in which the single hydrocarbon radicals between two oxygen atoms contain 2 or 3 carbon atoms.

Particularly worth mention as (A) are oligohydroxyalkanes of formula
X₀—(OH)ₓ (I′),
in which X₀ is the x-valent radical of a saturated aliphatic hydrocarbon with 2 to 6 carbon atoms
and x is a number in the range of 2 to 6 which is ≦ the number of carbon atoms in X₀.

(A) may in particular be selected from
(A₁) an oligohydroxyalkane with 3 to 6 carbon atoms and with x1 hydroxy groups, wherein x1 is a number in the range of 3 to 6 and is ≦ the number of carbon atoms in the alkane radical, or a mixture of two or more thereof,
(A₂) a diol which is an alkanediol containing 2 to 6 carbon atoms or a polyalkyleneglycol in which alkylene contains 2 or/and 3 carbon atoms or a mixture of two or more thereof,
   and a mixture of one or more of (A₁) with at least one (A₂).

Preferred oligohydroxyalkanes (A₁), i.e. oligohydroxyalkanes (A₁₁), may be represented by the following general formula
X₁—(OH)ₓ₁ (Ia),
in which X₁ signifies the x1-valent radical of a C₃₋₆-alkane
and x1 signifies a number in the range of 3 to 6, and is a number from 3 to the number of carbon atoms in X₁,

As oligohydroxyalkanes of formula (Ia) there may be employed known compounds, e.g. glycerol, threitol, erythritol, pentaerythritol, trimethylol-ethane or -propane and reduction products of conventional carbohydrates with five or six carbon atoms, such as arabitol, xylitol, sorbitol, mannitol and dulcitol.

Preferred compounds (A₁₁) of formula (Ia) are those of formula
H—(CHOH)ₓ₁—H (Ia′),
mainly glycerol, erythritol, arabitol, xylitol, sorbitol, mannitol and dulcitol, among which glycerol and sorbitol are particularly preferred.

Preferred diols (A₂) may be represented by the following general formula
HO—X₂—OH (Ib),
in which X₂ signifies the divalent radical of an alkane containing 2 to 6, preferably 2 to 4 carbon atoms or of a saturated aliphatic mono or polyether in which the alkylene radicals contain 2 or 3 carbon atoms.

As diols (A₂) there may in particular be mentioned alkanediols (A₂₁) of formula
HO—X₃—OH (Ic),
in which X₃ signifies C₂₋₆-alkylene, preferably C₂₋₄-alkylene,
and saturated aliphatic etherdiols (A₂₂) of formula
   HO—(X₄—O)ₓ₄—X₄—OH (Id),
in which X₄ signifies C₂₋₃-alkylene,
and x4 signifies a number in the range of 1 to 20.

The C₂₋₆-alkanediols (A₂₁) include e.g. 1,2- or 1,6-hexanediol, 2-methyl-2,4-pentanediol, 3-methyl-1,5-pentanediol, 1,2- or 1,5-pentanediol, or preferably C₂₋₄-monoalkyleneglycols, among which are preferred those of formula
HO—X₃′—OH (Ic′),
in which X₃′ signifies C₂₋₄-alkylene,
e.g. α- or β-butylene glycol, propylene glycol and ethylene glycol, preferably C₂₋₃-monoalkyleneglycols, i.e. propylene glycol and ethylene glycol.

In the etherdiols (A₂₂) the alkylene groups X₄ may have equal or different significances. Preferably at least some of the groups X₄ signify ethylene, more preferably at least 50% of the groups X₄ present in the molecule signify ethylene, most preferably all X₄ signify ethylene. The etherdiols (A₂₂) preferably are oligoalkylene glycols of formula (Id) in which the average number x4 preferably is 1 to 9, most preferably 1 to 7.

The compounds of formula (Ia′) with four to six carbon atoms may be employed in the form of racemic mixtures or of single optical isomers; they are solid at ambient temperature and are thus preferably employed in admixture with at least one liquid compound selected e.g. from glycerol, ethylene glycol and propylene glycol, so that the mixture is liquid at least at reaction temperature. The quantitative ratio of such mixtures is chosen suitably so that the mixture is liquid at the chosen reaction temperature; a mixture of one part by weight of compound (A), especially of formula (I), with two to three carbon atoms with 1 to 4 parts by weight of compound of formula (Ia) or (Ia′) with four to six carbon atoms already provides a liquid mixture.

According to a preferred feature of the invention there is employed a diol (A₂)—preferably (A₂₂) or more preferably (A₂₁), especially a C₂₋₃-monoalkyleneglycol—or/and glycerol or a mixture of a C₂₋₃-monoalkyleneglycol or glycerol with a compound of formula (Ia′) in which x1 is 5 or 6. Where there is employed such a mixture of diol or glycerol with a compound of formula (Ia′) in which x1 is 5 or 6, the weight ratio of diol or glycerol to the other compound may range in a broad scope, e.g. from 0.25:1 to 10:1, preferably 0.5:1 to 5:1, more preferably 0.8:1 to 2:1.

The molar ratio m of epichlorohydrin (B) to oligohydroxycompound or mixture (A) is in the range of 2 moles to 1.2·x moles of (B) per mole of (A). For (A₁) it is preferably in the range of 2.2 moles to 1.2·x moles, more preferably 2.5 moles to 1.1·x moles, of epichlorohydrin for every mole of oligohydroxycompound or mixture (A₁). For diols (A₂) it is preferably in the range of 2 to 2.2 moles of epichlorohydrin for every mole of diol (A₂).

The reaction of (A) with (B) is preferably carried out in the absence of any other solvent and in the presence of a catalyst, which is e.g. a Lewis acid, e.g. tin tetrachloride or preferably boron trifluoride e.g. in the form of its etherate or acetic acid complex. This reaction is an addition reaction of the epichlorohydrin to a hydroxy group, with opening of the epoxy ring and formation of a 2-hydroxy-3-chloropropyl-1 radical. This reaction is exothermic and the reaction temperature is preferably kept below 100° C., more preferably in the range of 60 to 85° C., e.g. with cooling. The epichlorohydrin reacts with the available hydroxy groups of (A) and, as reaction proceeds, may also react with a hydroxy group of a 2-hydroxy-3-chloropropyl-1 radical formed during the reaction, so that some of the hydroxy groups of (A), in particular of the compounds of formula (I), may even remain non-reacted with (B). Depending on the molar ratio, on the functionality of the oligohydroxycompound (e.g. the value of x or x1) and on the optical configuration of (A) or (A₁), primarily of the compounds of formula (Ia) or (Ia′)—especially if x1 is 4 to 6—the degree of reaction of the OH groups of (A) with (B) may vary, and may e.g. be in the range of 50 to 95%, mostly 75 to 95%, of the total number of OH groups originally present in (A).

The obtained adduct (E) is a chloro-terminated product. Referred to formula (a) it may be represented by the formula 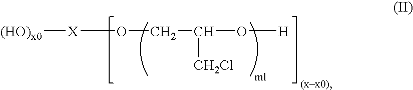
wherein x0 is the number of hydroxygroups linked to X which have not reacted with (B) in favour of a corresponding number of hydroxygroups introduced with (B), and the sum Σm1, which on average corresponds to (x−x0)·m1, equals m.

As may be deduced from the above mentioned degree of reaction of the hydroxygroups of (A) with (B), x0 may range e.g. in the scope of 0 to 0.5·m, mostly in the scope of 0.05·m to 0.25·m.

In each of the (x−x0) radicals of formula 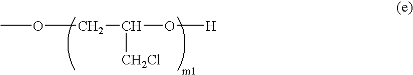
m1 may have the same or different values; mostly m1 signifies 1 or 2.

Dehydrochlorination of (E) to (E_{X}) may be brought about under reaction conditions conventional per se, e.g. those mentioned above, with the addition of a base suitable for dehydrochlorination, e.g. alkali metal hydroxide, typically sodium hydroxide, e.g. to an initial pH in the range of 9 to 12. Referred to formula (I) or (II) the dehydrochlorinated product may be represented by the formula 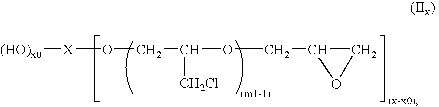
and where ml is >1 the reaction with (C) and optionally (D) will be a combined addition reaction to the epoxide ring and a condensation with the chlorohydrin entity.

The so produced adduct (E) or its dehydrochlorinated derivative (E_{X}) is then reacted with (C) and optionally (D), in the ratio of n moles of (C) and p moles of (D) for every mole of (E) or (E_{X}).

As amino compounds (C) there may be employed known compounds, in particular ammonia and aliphatic mono- or oligoamines, in particular
(C′) monoamino compounds containing in the basic form two reactive hydrogen atoms bonded to the nitrogen atom, more particularly
   (C₁) ammonia
   and (C₂) at least one primary aliphatic monoamine, e.g. a C₁₋₃-alkylamine or C₂₋₃-alkanolamine,
and (C″) oligoamines containing in the basic form at least two reactive hydrogen atoms bonded to two nitrogen atoms, the aliphatic bridging groups between two amino nitrogen atoms being expediently low molecular, preferably with ≦6 carbon atoms, and any substituents at the amino nitrogens being expediently also low molecular, preferably with ≦6 carbon atoms, more preferably with 1 to 3 carbon atoms, more particularly
   (C₃) at least one aliphatic diamine containing two secondary amino groups and no further amino groups,
   and (C₄) at least one aliphatic oligoamine containing at least one primary amino group and at least one further amino group which is primary or secondary.

Ammonia, having in the basic form three hydrogens, may be considered as being trifunctional, but the reaction of the third hydrogen with the chlorohydrin may be more difficult due to at least partial sterical hindrance, and thus for the purpose of the present reaction it may be employed or considered as a difunctional amino compound.

In the amines (C″) and (D) the aliphatic bridging groups between two amino nitrogen atoms are expediently low molecular, preferably with ≦6 carbon atoms, more particularly with 2 to 6 carbon atoms, and any substituents at the amino nitrogens are expediently also low molecular, preferably with ≦6 carbon atoms, more preferably with 1 to 3 carbon atoms. The aliphatic bridging groups and substituents are preferably saturated.

As (C₃) there may be mentioned e.g. N,N′-dimethyl-ethylenediamine.

The definition of (C₄) as at least one aliphatic oligoamine containing at least one primary amino group and at least one further amino group which is primary or secondary, means as (C₄) in particular at least one aliphatic oligoamine containing a primary amino group and a further amino group which is primary or secondary, any still further amino groups being secondary,

As amines (C₄) there may in particular be employed known aliphatic oligoamines with bridging C₂₋₆-alkylene groups, and containing one or two primary amino groups, any further amino groups being secondary. A terminal amino nitrogen may be substituted with an aliphatic substituent that does not interfere with the reaction, preferably with low molecular alkyl or hydroxyalkyl, so long as at least one of the amino groups is a primary amino group and any further amino group is secondary. The oligoamines (C₄) preferably contain ≦6 amino groups, more preferably 2 to 4 amino groups.
(C) preferably is (C₄), more preferably
   (C₄′) at least one oligoamine of formula 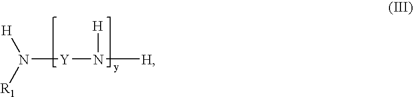
      wherein R₁ signifies hydrogen or C₁₋₃-alkyl,
         y signifies a number from 1 to 3
      and Y signifies C₂₋₃-alkylene, if y is 2 to 3,
         or signifies C₂₋₆-alkylene, if y is 1.

If y=2 to 3, the bridging alkylene Y may be ethylene, propylene-1,2 or propylene-1,3, of which ethylene and propylene-1,3 are preferred, especially ethylene. If y=1, the bridging alkylene Y may be e.g. ethylene, propylene-1,2, propylene-1,3 or tetra- to hexamethylene, of which ethylene, propylene-1,3 and hexamethylene are preferred, in particular propylene-1,3 and especially ethylene. If R₁ signifies C₁₋₃-alkyl it preferably stands for ethyl or methyl, more preferably methyl. Most preferably R₁ stands for methyl or especially hydrogen. The index y preferably signifies a figure in the range from 2 to 3.

As amines (D) there may be employed known aliphatic mono- or diamines in which at least some of the amino nitrogens are substituted with an aliphatic substituent that does not interfere with the reaction, preferably low molecular alkyl or hydroxyalkyl, so long as it contains at most one primary or secondary amino group; in the diamines the bridging group preferably is C₂₋₆-alkylene, more preferably C₂₋₃-alkylene.,
(D) preferably is
   (D₁) at least one aminocompound of formula 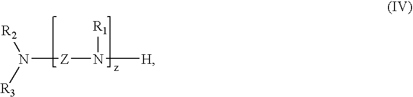
      wherein Z signifies C₂₋₆-alkylene,
         z signifies 0 or 1,
         R₂ signifies C₁₋₃-alkyl
      and R₃ signifies C₁₋₃-alkyl.

The bridging alkylene Z may be e.g. ethylene, propylene-1,2, propylene-1,3, or tetra- to hexamethylene, of which ethylene, propylene-1,3 and hexamethylene are preferred, in particular propylene-1,3. The index z preferably signifies 1. R₂ preferably stands for ethyl or methyl, most preferably for methyl. R₃ preferably has the same significance as R₂ and stands for ethyl or methyl, most preferably for methyl. R₁ most preferably stands for hydrogen.

Preferably (P) is the reaction product of (E) or (E_{X}) with (C₄′), wherein (A) is a compound or mixture of formula (I′), in particular a compound of formula (Ia′) or a compound of formula (Ic′) or a mixture of two or more thereof, and (C₄′) is of formula (III) in which R₁ signifies hydrogen or methyl and Y signifies ethylene, propylene or hexamethylene. Particularly preferred among these are those in which (A) is selected from glycerol, sorbitol, ethylene glycol, propylene glycol and mixtures of two or more thereof, and (C₄′) is selected from ethylenediamine, diethylenetriamine, triethylenetetraamine, hexamethylenediamine and mixtures of two or more thereof.

Since the reaction of (B) with (A) or respectively (A₁) is practically quantitative, the figure m represents also the number of linked terminal chlorine atoms in (E). The ratio of (C) and (D) to (E) or (E_{X}) and the total number t of basic aminogroups per mole of [(C)+(D)], referred to the non-protonated form, are suitably chosen in such a range that polymeric products (P) can result and the chlorine atoms of (E) are reacted with (C) and optionally (D) to at least 50%, preferably >60%, more preferably >70%. The ratio of (C) and (D) to (E_{X}) is chosen analogously. The figure t also indicates the total number of molequivalents of [(C)+(D)] referred to basic amino groups present in the non-protonated form of [(C)+(D)]. Preferably the total number t₁ of molequivalents of [(C)+(D)] referred only to primary and secondary aminogroups present in (C) and (D) is in excess over m.

The molar ratios n and p are expediently chosen so that polycondensation and/or polyaddition leading to the polymeric etheramine (P) can be brought about. Preferably n is a number >0.4·m and <m, more preferably ≧0.5·m and <m. p is a number ≧0. Preferably n+p<m.

Where (C) is (C′), this is employed in the molar ratio of n′ moles of (C′) for every mole of (E) or (E_{X}), and n′ preferably is a number >0.4·m and <m, more preferably ≧0.5·m and <m. If there is reacted also (D) in the molar ratio of p′ moles of (D) for every mole of (E) or (E_{X}), preferably n′+p′<m and 2·n′+p′>m.

Where (C) is (C″), this is employed in the molar ratio of n″ moles of (C″) for every mole of (E) or (E_{X}), and n″ preferably is a number >0.4·m and <m, more preferably ≧0.5·m and <m. If there is reacted also (D) in the molar ratio of p″ moles of (D) for every mole of (E) or (E_{X}), preferably n″+p″>0.5·m and <m.

According to a particular aspect of the invention, as (P) there is employed (P₁) i.e. a product obtainable by reaction of (A₁) with (B) in the ratio of m′ moles of epichlorohydrin for every mole of oligohydroxycompound (A₁), in which m′ is >2 and at most 1.2·x1, to give a chloro-terminated adduct (E₁), and optionally dehydrochlorination of (E₁) to (E_{X1}), and polycondensation reaction of (E₁) with (C₄) or reaction of (E_{X1}) with (C₄) in the molar ratio of n4 moles of (C₄) for every mole of (E₁) or (E_{X1}), wherein n4>0.5·m′ and <m′, and optionally (D) in the molar ratio of p′ moles of (D) for every mole of (E₁) or (E_{X1}), wherein p′≧0 and <(m′−n4), and the total number t4 of basic amino groups in (C₄)+(D) is higher than the total number of linked chlorine atoms in (E₁), and which is optionally protonated.

According to another feature of the invention there are employed polymers (P₂) obtainable by reaction of (A₂) with (B), in the ratio of m″ moles of epichlorohydrin for every mole of compound (A₂), in which m″ is a number in the range of 2 to 2.2, to give a chloro-terminated adduct (E₂), and optionally dehydrochlorination to (E_{X2}), and reaction of (E₂) or (E_{X2}) with (C″) in the molar ratio of n″ moles of (C″) for every mole of (E₂) or (E_{X2}), wherein n″ is ≧0.5·m″ and <m″, and optionally with (D) in the molar ratio of p″ moles of (D) for every mole of (E₂) or (E_{X2}), wherein p″≧0 and <(m″−n″), and the total number of nitrogen atoms in (C″)+(D) is higher than the total number of linked chlorine atoms in (E₂).

(C″) preferably is (C₄).

The process for the production of (P₁) is thus characterized in that (A₁) is reacted with (B) in the ratio of m′ moles of (B) for every mole of compound (A₁) to give a chloro-terminated adduct (E₁) and optionally dehydrochlorinated to (E_{X1}), and (E₁) or (E_{X1}) is reacted with (C₄) and optionally (D), in the above mentioned ratio of n4 moles of (C₄) and p′ moles of (D) for every mole of (E₁) or (E_{X1}). Analogously, the process for the production of (P₂) is thus characterized in that (A₂) is reacted with (B) in the ratio of m″ moles of (B) for every mole of compound (A₂) to give a chloroterminated adduct (E₂) and optionally dehydrochlorinated to (E_{X2}), and (E₂) or (E_{X2}) is reacted with (C₄) and optionally (D₁) in the above mentioned ratio of n″ moles of (C″) and p″ moles of (D) for every mole of (E₂) or (E_{X2}).

According to one feature of the process, the reaction conditions are preferably chosen in such a way that (C) or (C₄) is sufficient for condensation reaction with the available terminal chlorine of (E) or (E₁) or respectively (E₂), and no (D) is required.

When (A) is (A₁), sum n+p preferably is a figure in the range of 0.5·m to (m−0.1), more preferably 0.5·m to (m−0.2).

p preferably is 0 to 2·n, e.g. 0. If (D) is employed, p preferably is ≧0.25·n, e.g. a figure in the range of 0.25·n to 2·n.

The total number of basic aminogroups present in [(C′)+(D)] is preferably >0.5·m and <m.

The total number of basic aminogroups—i.e. of primary, any secondary and any tertiary basic amino groups, preferably of primary and any secondary basic amino groups—present in [(C″)+(D)] is higher then the total number of chlorine atoms present in (E), so that the chlorine atoms in (E) are reacted with (C) and any (D), and t—and preferably also t₁—is >m, preferably >1.2·m, more preferably >1.5·m. Referred to formulae (III) and (IV) in particular n·(y+1)+p·(z+1)>m, preferably >1.2·m, more preferably >1.5·m. More particularly n·(y+1)+p·z>m, preferably >1.2·m, more preferably >1.5·m. The ratio to (E_{X}) is chosen analogously.

The total number of primary amino groups present in [(C)+(D)], in particular in [(C″)+(D)], preferably in [(C₄)+(D)], is preferably more than twice, more preferably more than 2.5 times, the total number of tertiary amino groups of diamine (D) present in [(C″)+(D)], or of secondary monoamine (D) present in [(C″)+(D)], so that either no diamine or secondary monoamine (D) is used and the product is practically exempt of any quaternary ammonium groups, or if any diamine or secondary monoamine (D) is used, and may lead to quaternary ammonium groups, these are present in a minor proportion of the total of quaternary ammonium groups and non-quaternary amino groups present, e.g. ≦30% e.g. 2 to 30% of the total of the quaternary ammonium groups and non-quaternary amino groups present, preferably ≦25% e.g. 3 to 25% of the total number of quaternary ammonium groups and non-quaternary amino groups present. Thus the resulting product is either exempt of any quaternary ammonium groups, or, if any quaternary ammonium groups are present, their number is preferably ≦30%, preferably ≦25% of the total number of quaternary ammonium groups and non-quaternary amino groups present.

The polymeric product (P) may optionally be crosslinked.

The condensation reaction of (C) and any (D) with (E) is carried out preferably in aqueous medium, e.g. at a water content in the range of 10 to 90%, preferably 20 to 88%, referred to the total weight of the aqueous reaction mixture, and preferably with heating, e.g. at a temperature in the range of 30 to 90° C., preferably 40 to 70° C. During the reaction the basicity of the amines (C) and, if present, also (D) may be sufficient for the alkylation of (C) and respectively (D) with the chloride (E) used as an alkylating agent; if desired there may even be employed a strong base, e.g. potassium hydroxide or preferably sodium hydroxide. The pH of the reaction mixture is preferably in the range of 7 to 10. (D) may be added e.g. simultaneously with (C) or even subsequently to (C). If in the reaction there has been employed a proportion of (C) which alone is insufficient for reacting with all covalently linked chlorine the required amount of compound (D) may be added to complete the reaction of (E). When the reaction has completed or has reached the desired degree, the reaction mixture is suitably acidified by addition of a conventional acid, preferably a mineral acid (such as hydrochloric acid, sulphuric acid or phosphoric acid) or a low molecular aliphatic carboxylic acid e.g. with 1 to 6 carbon atoms (such as formic acid, acetic acid, citric acid or lactic acid), preferably to reach a pH below 6, more preferably in the range of 3.5 to 5.5, most preferably 4 to 4.5. Dehydrochlorination to the epoxide (E_{X}) may be carried out under similar conditions, employing a suitable amount of alkali metal hydroxide, preferably sodium hydroxide. The proceeding of the reaction may be pursued by chloride-ion titration or by checking the viscosity of the reaction mixture, which gives an empirical impression of the degree of polymerisation and crosslinking, or both. A suitable chloride ion content is e.g. ≧50% of the theoretical value, preferably >60%, more preferably >70%. A suitable viscosity is e.g. ≦5000 cP, preferably in the range of 200 to 3000 cP.

Preferably with (A₁) and with amines (C₄) there may in particular be produced
(P_{A}) polymeric, crosslinked, protonated etheramines (P) in which n4 is a number in the range of from 0.4·m to 0.72·m, and p<0.25·n4,
(P_{B}) polymeric, protonated etheramines (P) in which n4 is a number in the range of from 0.72·m to (m−0.1), and p<0.25·n4, which may be crosslinked.
and (P_{C}) polymeric, crosslinked, protonated etheramines (P) in which n4 is a number in the range of from 0.2·m to 0.6·m, and p≧0.25·n.

In (P_{A}) and (P_{B}) preferably p=0.

The obtained polycationic polymers (P) may schematically be represented, at least for the derivatives of compounds of formula (II), by the following average formula: 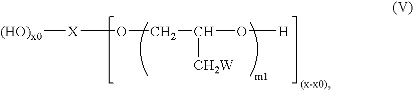
wherein each W independently signifies the radical derived from (C) or respectively (D), at least two being (C)-derived, and two or more (C)-derived symbols W of a same molecule or of two or more different molecules form together a bridge derived from the polymerisation and optionally cross-linking condensation reaction of (C).

The so produced (P)-containing compositions—in particular aqueous compositions (W_{P})—are ready for use or may, if desired, be adjusted in (P)-content by dilution with water or evaporation or be desalinated and optionally concentrated by membrane filtration through a semipermeable membrane. They are distinguished by their stability, in particular also to storage and transportation, also under conditions of heat or frost.

The concentration of (P) in the aqueous composition (W_{P}) as produced is e.g. in the range of 5 to 60% by weight, preferably in the range of 10 to 60% by weight, more preferably 12 to 50% by weight.

If desired, the produced aqueous compositions—optionally after conversion of the salt form to a basic form by suitable neutralization with a base (e.g. by addition of sodium hydroxide or potassium hydroxide)—may be dried to powders or granular products. For use the dry powders or granular products may, if desired, be mixed with water—and if required an acid, e.g. hydrochloric acid, for protonation of a basic form—to produce again an aqueous composition (W_{P}). Preferably, however, they are employed directly in the form of the produced aqueous concentrate compositions (W_{P}).

The above polymeric, optionally crosslinked etheramines (P), optionally in the form of the mentioned aqueous compositions (W_{P}), in their protonated form are of polycationic character and are readily dilutable with water. They may be used as such, preferably in the form of the concentrated aqueous composition (W_{P}), and may if desired be further pre-diluted to suitable stock solutions, e.g. of a concentration in the range of 1 to 12% by weight, before addition to the treatment liquors.

As substrates (T) are suitable any textile substrates of natural, semisynthetic or synthetic fibres, dyeable with the corresponding water soluble dyes, e.g. of natural or synthetic polyamides (e.g. wool, silk, nylon 6, nylon 66), of polyurethanes, of polyacrylics and/or cellulosic substrates, in particular of non-modified and non-regenerated cellulose (e.g. cotton, hemp, linen) or of regenerated or modified cellulose (cellulose acetates, viscose, lyocell). The textile substrate may be in any form as conventional per se and suitable for dyeing or printing in textile industry, especially textile material in any suitable textile processing form subsequent to spinning, for example in the form of yarns, of threads, of synthetic or semisynthetic, optionally texturised monofilaments, yarns or strands, of spunbonded polyamide or viscose, of cross-wound bobbins or cheeses, of fabrics (in particular as wovens, knits, tuftings, terry cloth or velvets), of felts or of ready-made or half ready-made goods. Textile synthetic or semisynthetic filaments may also be in the form of hollow fibres or microfibres. For the dyeing or printing of synthetic fibrous material or of blends of cellulosic material with synthetic fibrous material (e.g. with synthetic polyamides, polyurethanes, polyesters or/and polyacrylics) there may also be employed in addition to the water soluble dyes corresponding suitable other dyes, e.g. disperse dyes or/and pigments. With particular preference (T) is in the form of fabric, especially woven or knitted goods, and depending on the employed dyeing system, may be in endless form or in the form of piece goods, e.g. in tubular form or as open widths.

The water soluble dyes (F) may include e.g. anionic and cationic dyes, such as defined e.g. in the Colour Index as Basic Dyes, Acid Dyes, Mordant Dyes, Sulphur Dyes (including also the modifications Solubilized Sulphur Dyes i.e. Bunte salts, and Condense Sulphur Dyes, and also Sulphurised Vat Dyes), Vat Dyes, Direct Dyes and Reactive Dyes. That they are water soluble means that they are dissolved in water at least under application conditions. The sulphur or vat dyes are applied suitably in their leuco form. Preferably as (F) there are employed cationic dyes, sulphur dyes (applied as leuco sulphur dyes), acid dyes, direct dyes and fibre reactive dyes. The dyes are judiciously selected according to the substrate to be dyed or printed; e.g. for cellulosic substrates in particular cationic dyes, sulphur dyes (applied as leuco sulphur dyes), direct dyes and fibre reactive dyes, for polyamidic fibres and polyurethane fibres in particular acid dyes and fibre reactive dyes, for acrylic fibres in particular cationic dyes.

The process of the invention is particularly suitable for dyeings and prints produced with reactive, direct, acid, basic or sulphur dyes.

Any desired conventional dyeing and printing processes are suitable, for example exhaust processes (in any conventional dyeing vessels suitable for exhaustion dyeing, including e.g. J-dyeing machines, winch becks, jiggers and jet dyeing machines), impregnation processes (primarily padding and dipping) and printing processes.

Exhaust dyeing processes may be conducted using any desired conventional liquor-to-goods ratios (e.g. from 2:1 to 100:1) and temperatures (for example in the range from 40° C. to boiling temperature, mostly from 60 to 98° C., or for so-called cold dyeing reactive dyestuffs even from 15 to 50° C., mostly 20 to 40° C.). The particular dyeing conditions suitably are those known or recommended for the particular type of substrate and dye.

For the dyeing of cellulosic fibre material with reactive dyes the known salts (e.g. Glauber's salt or sodium chloride) may be added in appropriate concentrations, for example from 5 to 80 g/l, to the liquors, and following the desired dyeing time an alkali, for example sodium hydroxide and/or sodium carbonate, is advantageously added in order to fix the dye reactively, advantageously in the pH range from 9 to 13, preferably from 10 to 12. Exhaustion dyeing may then be completed by conventional soaping and/or washing and rinsing and optionally drying.

For the dyeing of cellulosic fibre material with direct dyes the dye bath is suitably alkaline by addition of soda (e.g. at pH 8-11) and known salts (e.g. Glauber's salt) may be added in appropriate concentrations, for example from 5 to 80 g/l, portionwise to the liquors. Dyeing may be conducted e.g. by starting at a temperature in the range of 20 to 40° C. and heating to the desired exhaustion temperature, e.g. in the range of 60 to 110° C. The dyeing may then be completed by conventional washing and/or rinsing and optionally drying.

Dyeing with sulphur dyes is suitably carried out under strongly alkaline conditions, preferably at pH values ≧10, in particular in the range of 10 to 14, in the presence of a conventional reducing agent (e.g. a reducing sugar or/and a sulphide) in order to maintain the reduced condition of the (pre)reduced sulphur dyes. Advantageously the concentration of the reducing agent ranges in the scope of 0.5 to 15% by weight, preferably 1 to 10% by weight, referred to the dry weight of the substrate. Also the dyeing temperature may vary depending on the dyeing method and dyeing apparatus, and is advantageously in the range of 35 to 130° C., mainly 45 to 105° C., preferably 60 to 100° C. When dyeing in a closed vessel, it may also be of advantage to dye under an inert gas atmosphere or/and under reduced pressure. The exhaustion phase may then be concluded with a rinsing step. After completion of the exhaustion stage the treated goods are subjected in a second stage to an oxidative treatment, in particular with an oxidising agent. In this second stage, which is advantageously carried out under acidic conditions, the dye is oxidised on the substrate, in particular in order to achieve colour development and a degree of fastness. Any oxidising agents as are per se conventionally employable for sulphur dyes may be employed, e.g. a gaseous form of oxygen (oxygen, ozone, air, or air enriched with oxygen and/or ozone, or a blend of inert gas with oxygen and/or ozone), hydrogen peroxide or preferably an oxidising salt, e.g. sodium or potassium perborate, percarbonate, bichromate, chlorate, iodate or bromate, the latter preferably in the presence of a suitable activator such as e.g. alkali metal metavanadate; of these the bromate is particularly preferred, especially in the presence of sodium or potassium metavanadate. The oxidation is advantageously carried out with mild heating, preferably in the temperature range of 40 to 75° C., particularly preferably 45 to 70° C., and at a pH in the range of 4 to 6, preferably 4.5 to 5.5. Upon completion of the second stage the oxidised dyegoods may be rinsed and neutralised, e.g. with sodium carbonate, as conventional per se after a sulphur dye dyeing, and completed in conventional way e.g. by rinsing and optionally drying.

For the dyeing with basic dyes are suitable mainly acid-modified synthetic textile fibres (e.g. polypropylene, polyamide, polyurethane), acrylic fibres, cellulosic fibres, wool or silk. By exhaust methods the dyeing may be carried out at liquor-to-goods ratios conventional per se, e.g. in the range of 120:1 to 4:1, depending on the chosen apparatus and material, preferably with heating e.g. at temperatures in the range of 50° C. to the boil, preferably 60 to 98° C., or also above, e.g. 102 to 130° C., with superatmospheric pressure. The pH may range in a scope as conventional for cationic dyes, e.g. pH 4 to pH 8. The dyeing may then be concluded in conventional way by rinsing and optionally drying.

For the dyeing with acid dyes are suitable mainly synthetic and/or natural polyamide textile fibres e.g. nylon, wool or silk. By exhaust methods the dyeing may be carried out at liquor-to-goods ratios conventional per se, e.g. in the range of 120:1 to 2:1, depending on the chosen apparatus and material, preferably with heating e.g. at temperatures in the range of 50° C. to the boil, preferably 60 to 98° C., or also above, e.g. 102 to 130° C., with superatmospheric pressure. The pH may range in a scope as conventional for acid dyes, e.g. pH 3.5 to pH 6.5 for acid uptake dyes, and pH 4.5 to pH 8 for so-called neutral uptake dyes. The dyeing may then be concluded by conventional washing and/or rinsing and optionally drying.

As impregnation methods come into consideration any conventional continuous impregnation processes, e.g. padding or dipping, followed by a thermal fixation above 100° C., e.g. within 102 and 150° C., e.g. by drying, steaming or thermosoling, or by cold dwelling, optionally with intermediate pre-drying. Prints may also be fixed in this way.

Continuous impregnation processes for the textile substrates can be carried out, for example, with liquors of a pH as suitable for the particular substrate and dye, advantageously within the pH ranges mentioned above for exhaustion, it being advantageous to carry out impregnation without heating (for example at from 15 to 25° C., or also up to 40° C. depending on the ambient climatic conditions) and to fix the impregnated goods either by cold dwelling or, optionally after an intermediate drying, by heat treatment, for example with steam or dry heat.

Printing may also be carried out in conventional manner, e.g. with printing pastes or inks, for example in one phase or in two phases. If printing is done in one phase, the printing ink or paste may also contain a suitable acid (optionally in the form of a hydrolysable precursor such as a lactone) or base as required for fixation, and fixing takes place advantageously by steaming or with dry heat in a manner analogous to that described above. If printing is done in two phases (as may e.g. be suitable for reactive dyes or sulphur dyes), the dye is applied in the first phase. This printing ink or paste advantageously is neutral to weakly acidic (e.g. pH 4 to 7) for reactive dyes, and the alkali for fixation is applied in the second phase, after an intermediate drying, advantageously by means of a minimal add-on applicator, preferably such that the moisture content is ≦30% of the dry weight of the substrate. Here again, fixing takes place judiciously by means of treatment with steam or dry heat, or also by leaving the goods to lie at room temperature. For sulphur dyes the printing paste or ink advantageously is alkaline as mentioned above for the exhaustion method, and the acid and oxidising agent for re-oxidation is applied in the second phase, after an intermediate drying, advantageously by means of a minimal add-on applicator, preferably such that the moisture content is ≦30% of the dry weight of the substrate. Here again, fixing takes place judiciously by means of treatment with steam or dry heat, or also by leaving the goods to dwell at room temperature. Alternatively re-oxidation of sulphur dyeings or prints may also be accomplished simply by exposing the leuco dyed or printed substrate to air oxygen.

The dye-containing printing inks and pastes may comprise conventional further components, e.g. suitable thickeners, mainly alginates, carob gum ethers and/or polyacrylates. If desired, a hydrotrope, principally urea, may be added to the printing pastes or inks. The water content and thickener content of the printing pastes is advantageously chosen such that the viscosity is within the range from 1000 to 8000 cP, preferably from 2000 to 6000 cP, at room temperature (=20° C.). The prints may advantageously be fixed by a thermal fixation above 100° C., e.g. by drying, steaming or thermosoling, optionally with intermediate pre-drying.

The produced dyeings or colour prints (T_{F}) may then be aftertreated with the products (P). Aftertreatment with (P) may be carried out from aqueous medium, analogously to conventional exhaustion or impregnation methods, e.g. those mentioned above for dyeing. Exhaustion methods being in particular also of advantage for those substrates to which basic or cationic dyes are substantive (typically cellulosic substrates and acid modified synthetic substrates).

For the production of the required application liquors, namely exhaustion baths or impregnation compositions, (P) may be employed in dry form or preferably in the form of aqueous concentrated compositions (W_{P}), especially solutions, e.g. with a (P)-concentration in the range of 5 to 60% by weight, or in pre-diluted form e.g. as a stock solution, e.g. with a (P)-content in the range of 0.5 to 10% by weight.

Aftertreatment of (T_{F}) with (P) is advantageously carried out with an aqueous medium, under pH conditions suiting the particular substrate and dyeing or print, and which may range in particular in the range from distinctly acidic to distinctly alkaline conditions, e.g. in the range of pH 3 to pH 12, preferably pH 5 to 9.

If aftertreatment with (P) is carried out by impregnation, there may e.g. be employed a padding liquor containing (P) in a concentration e.g. in the range of 0.02 to 50 g/l, preferably 0.1 to 30 g/l, ore preferably 0.2 to 20 g/l. Impregnation may be carried out by methods conventional per se, in particular by dipping, spraying or preferably padding, suitably to a pick-up providing the required concentration of (P) referred to the substrate, e.g. at a temperature in the range of 15 to 40° C., followed by heating, preferably dry heating, e.g. to a temperature ≧98° C., preferably in the range of 102-140° C.

If aftertreatment with (P) on a substrate of appropriate affinity, preferably on dyed or printed cellulose (T_{FC}), is carried out by exhaustion, the liquor-to-goods ratio may range in a broad scope, as may suit the application system and the substrate, e.g. in the range of 4:1 to 40:1, usually 5:1 to 30:1, preferably 5:1 to 20:1, depending on the system, and preferably with heating, e.g. at a temperature in the range of 15 to 70° C., preferably 30-60° C. Exhaustion of (P) may be carried out suitably for a time sufficient for the desired exhaustion of (P) on the substrate, e.g. for 5 to 60 minutes, mostly 10 to 40 minutes. The substrates aftertreated with (P) may then be rinsed and dried in conventional way.

(P) is expediently employed in an efficient concentration, depending on the particular substrate and dyeing or print, and especially on the possible concentration of active chlorine in the substrate and its damaging potential on the dyeing or print. The concentration of (P) referred to the substrate may range e.g. in the scope of 0.1 to 10%, preferably 0.2 to 5%, more preferably 0.4 to 2% by weight referred to the dry weight of the substrate (T).

According to a particular feature of the invention, where a dyeing of a substrate (T) of high affinity for basic dyes, preferably a cellulosic substrate, with (F), has been carried out by an exhaustion method, the aftertreatment with (P) may also be carried out by exhaustion. With particular advantage this aftertreatment is then carried out in the same machine, after the rinsing step that concludes the dyeing procedure before drying, in one sequence.

Analogously, according to another particular feature of the invention, where a dyeing of a substrate (T) with (F) has been carried out by impregnation, the aftertreatment with (P) may also be carried out by impregnation. With particular advantage this aftertreatment by impregnation is then carried out by an impregnation method of the same kind as the dyeing, and is carried out in the same machine or equipment, after the rinsing step that concludes the dyeing procedure before drying, in one sequence.

Exhaustion dyeings may however also by aftertreated by impregnation methods, or impregnation dyeings on a substrate (T) of high affinity for basic dyes, preferably on a cellulosic substrate, may also be aftertreated by exhaustion. Prints are preferably aftertreated with (P) by impregnation methods.

By this process there may be achieved dyeings and prints which, upon aftertreatment with (P), display an outstanding improvement of their fastness to chlorine (active chlorine in chlorinated water) as may be assessed e.g. according to the standard test method according to ISO E03, while the own shade and brilliance of the dyeing or print is substantially unaltered, and—especially where (P) is applied by exhaustion—the handle of the textile material is also optimally maintained. The dyeings and prints produced with reactive dyes, which after soaping and rinsing have been aftertreated with (P), display also satisfactory wet fastnesses. Analogously also the dyeings and prints produced with basic or cationic dyes or with sulphur or vat dyes likewise display satisfactory wet fastnesses upon aftertreatment with (P).

Where it is desired to improve the wet fastness of a dyeing or print, especially a dyeing produced with a direct or acid dye, a conventional dye fixative (X) may be employed, e.g. as mentioned above, in particular a cationic fixative (X′) or an anionic fixative (X″). Cationic fixatives (X′) are particularly suitable for dyeings or prints produced with mordant dyes or especially direct dyes or reactive dyes, while anionic fixatives (X″) are particularly suitable for dyeings and prints produced with acid dyes or basic dyes. Dyeings or prints produced with vat dyes or sulphur dyes mostly do not need a dye fixative, but if one is used, it is preferably a cationic dye fixative (X′). The dye fixative (X′) may be employed before (P), subsequently to (P) or preferably in admixture with (P). The dye fixative (X″) is preferably applied before (P). Accordingly a particular feature of the invention is represented by a mixture (M_{PX}) of (P) with (X′) and also by an aqueous composition (W_{PX}) comprising a mixture (M_{PX}) of (P) with (X′).

Suitable dye fixatives (X) are in particular polymeric products of cationic or anionic character.

Suitable dye fixatives (X′) may be selected from cationic products known per se in the art, and include e.g.
(X₁) Polycondensates of oligoamines with dicyandiamide and optionally further reactants,
(X₂) Polydiallyldialkylammonium salts (typically polydiallyldimethylammonium chloride),
(X₃) Quaternary condensates of epichlorohydrin—or of a precursor or derivative thereof—with a secondary amine or with a substituted oligoamine containing at least one or more tertiary amino group and optionally further reactants,
(X₄) Polyglycidyl ethers substituted with quaternary ammonium groups (e.g. reaction products of polyepichlorohydrins with trimethylamine, dimethylamine or triethanolamine),

Suitable dye fixatives (X″) may be selected from anionic products known per se in the art, and include e.g.
(X₅) phenolic and carboxylic compounds, e.g. as known for leather tanning
(X₆) Sulphogroup containing aromatic polycondensates e.g. with aldehydes, such as syntans.

Polycondensates of type (X) are well known in the art and also described in large extent in the specialised literature, several polycondensates of type (X) are also available on the market in various forms, mostly as aqueous concentrated compositions (W_{X}).

Representative polycondensates of type (X₁) are e.g. those described in U.S. Pat. Nos. 4,410,652, 4,452,606, 4,439,203, 4,764,585 and 2,649,354, especially polycondensates of dicyandiamide with diethylenetriamine, preferably in salt form, and which may have been further reacted with hydroxy and/or methylol substituted, optionally cyclic, ureas or with epichlorohydrin.

A representative polydiallyldialkylammonium salt of type (X₂) is in particular polydiallyldimethylammonium chloride also known as poly-DADMAC as mentioned e.g. in JP publication 53-70178.

Representative polycondensates of type (X₃) are e.g. those described in U.S. Pat. Nos. 4,599,087 and 4,718,918, GB patent 1114036 and JP publication 43-243.

Representative polycondensates of type (X₄) are e.g. those described in JP publication 51-112987.

As (X″) there may in particular be employed products known from leather (re)tanning technology e.g. as tannins and syntans.

As (X₅) there may e.g. be mentioned phenolic and carboxylic compounds of the tannin type, e.g. natural tannins, phenols, cathecols, gallic acid and derivatives therefrom.

As (X₆) there may e.g. be mentioned aromatic polycondensates of the syntan type, e.g. condensates of sulphonated phenols, naphthols, sulphonaphthalene and/or dihydroxydiphenylsulphones and optionally non-sulphonated phenols with an aldehyde, mainly with formaldehyde, and condensates of sulphonated phenols, dihydroxydiphenylsulphones and/or naphthols and/or of sulphonaphthalene.

Preferred fixatives (X) are the cationic ones, in particular those of type (X₁).

Preferably the fixatives (X) are employed in the form of aqueous concentrated compositions (W_{X}) with a dry substance content as usual, preferably in the range of 8 to 40%, more preferably 10 to 30% by weight.

Where the two products (P) and (X′) are used in admixture, it is of advantage to admix the two liquid aqueous forms (W_{P}) and (W_{X}′) with each other to produce a liquid aqueous composition (W_{PX}) containing the mixture (M_{PX}), and the invention thus further provides an aqueous composition (W_{PX}) comprising a mixture (M_{PX}) of (P) with (X′), preferably in dissolved form.

The weight ratio of (P) to (X) may range in a broad scope, e.g. from 10/1 to 1/5, preferably 5/1 to 1/3, more preferably 3/1 to 1/1. Preferably (P) outweighs (X). The (M_{PX})-content in (W_{PX}) may range in a broad scope, mainly depending on the employed components and their solubilities, and is e.g. in the range of 8 to 50%, preferably 10 to 30% by weight. The aqueous compositions (W_{PX}) are of notable stability to storage and transportation, especially if (X′) is (X₁).

The aftertreatment with the mixture (M_{PX}), or respectively with the composition (W_{PX}), may be carried out under the same conditions (pH, temperature, duration) as the aftertreatment with (P) alone, as described above.

The obtained dyeings and prints aftertreated according to the invention are distinguished by their outstanding fastness to chlorine, while shade and brilliance of the dyeings and prints of the treated substrate are maintained to a high degree and are practically unaltered, and the fastness improving treatment is also distinguished by a high resistance to washing. Also the other fastnesses, e.g. fastness to light and wet fastnesses, may be positively influenced by the process of the invention, especially where the aftertreatment includes also a treatment with (X) or respectively is carried out with (M_{PX}). The handle of the substrates treated according to the invention may also be maintained to a high degree, especially where the aftertreatment with (P) is carried out by exhaustion.

In the following Examples parts and percentages are by weight, if not otherwise indicated; parts by weight relate to parts by volume as grams to millilitres. The temperatures are indicated in degrees Celsius. The employed water is demineralised (deionised) water. The chloride ion content of the reaction mixture is determined by titration with an aqueous 0.1 N AgNO₃ solution. The dyes employed in the Application Examples are used in a commercial form, blended with sodium sulphate decahydrate and containing about 25% of pure dye. C.I. stands for Colour Index. Fastness to chlorine is assessed according to ISO E03, with 20 mg/l available chlorine.

### EXAMPLE 1

26.92 g of glycerol are heated to 80° C. and 0.2 g of boron trifluoride etherate are added with stirring. To this mixture 73.08 g of epichlorohydrin are added over 2 hours while maintaining the temperature at 80-85° C. with cooling. Stirring is continued for one further hour at 80° C. and then 80 g of water are added, by which the temperature drops to 50° C. 45 g of diethylenetriamine are added over two hours maintaining the temperature of the reaction mixture at 60° C. Stirring is continued at this temperature until the reaction mixture begins to thicken. 222.3 g of water are added and stirring is continued at 60° C. until the chloride ion content reaches 1.33 mol/kg. At this point the reaction is stopped by adding 36 g of formic acid of 85% concentration. The reaction mixture is then cooled to 40° C. and filtered. There are obtained 483 g of a 30% solution (W_{P1}) of product (P1).

### EXAMPLE 2

The procedure described in example 1 is repeated, with the difference that instead of 45 grams of diethylene triamine there are employed 55 grams, in place of 222.3 g of water there are employed 245.7 g and the reaction is stopped at a chloride ion content of 1.29 mol/kg. There are obtained 516 g of a 30% solution (W_{P2}) of product (P2).

### EXAMPLE 3

27.39 g of glycerol are heated to 80° C. and 0.2 g of boron trifluoride etherate are added with stirring. To this mixture 72.61 g of epichlorohydrin are added over 2 hours while maintaining the temperature at 80-85° C. with cooling. Stirring is continued for one further hour at 80° C. and then 80 g of water are added, by which the temperature drops to 50° C. 65 g of diethylenetriamine are added over two hours maintaining the temperature of the reaction mixture at 60° C. Stirring is continued at this temperature until the reaction mixture begins to thicken. 269 g of water are added and stirring is continued at 80° C. until the chloride ion content reaches 1.52 mol/kg. At this point the reaction is stopped by adding 36 g of formic acid of 85% concentration. The reaction mixture is then cooled to 40° C. and filtered. There are obtained 550 g of a 30% solution (W_{P3}) of product (P3).

### EXAMPLE 4

25.87 g of glycerol are heated to 80° C. and 0.2 g of boron trifluoride etherate are added with stirring. To this mixture 74.13 g of epichlorohydrin are added over 2 hours while maintaining the temperature at 80-85° C. with cooling. Stirring is continued for one further hour at 80° C. and then 80 g of water are added, by which the temperature drops to 50° C. 70 g of diethylenetriamine are added over two hours maintaining the temperature of the reaction mixture at 60° C. Stirring is continued at this temperature until the reaction mixture begins to thicken. 270.6 g of water are added and stirring is continued at 60° C. until the chloride ion content reaches 1.33 mol/kg. At this point the reaction is stopped by adding 46 g of formic acid of 85% concentration. The reaction mixture is then cooled to 40° C. and filtered. There are obtained 566 g of a 30% solution (W_{P4}) of product (P4).

### EXAMPLE 5

25.87 g of glycerol are heated to 80° C. and 0.2 g of boron trifluoride etherate are added with stirring. To this mixture 74.13 g of epichlorohydrin are added over 2 hours while maintaining the temperature at 80-85° C. with cooling. Stirring is continued for one further hour at 80° C. and then 80 g of water are added and the mixture is cooled to room temperature. At this temperature a solution of 47.2 g of hexamethylenediamine in 100 g of water is added and the mixture is heated to 70° C. Stirring is continued at this temperature until the reaction mixture begins to thicken. 148.2 g of water are added and stirring is continued at 60° C. until the chloride ion content reaches 1.19 mol/kg. At this point the reaction is stopped by adding 15 g of formic acid of 85% concentration. The reaction mixture is then cooled to 40° C. and filtered. There are obtained 490 g of a 30% solution (W_{P5}) of product (P5).

### EXAMPLE 6

26.92 g of glycerol are heated to 80° C. and 0.2 g of boron trifluoride etherate are added with stirring. To this mixture 73.08 g of epichlorohydrin are added over 2 hours while maintaining the temperature at 80-85° C. with cooling. Stirring is continued for one further hour at 80° C. and then 80 g of water are added, by which the temperature drops to 50° C. 60 g of diethylenetriamine are added over two hours maintaining the temperature of the reaction mixture at 60° C. Stirring is continued at 70° C. until the reaction mixture begins to thicken. 50 g of water are added and stirring is continued at 70° C. until the mixture begins again to thicken. 100 g of water are added and stirring is continued at 70° C. until the mixture begins to thicken again. 107.6 g of water are added and stirring is continued at 70° C. until the chloride ion content reaches 1.30 mol/kg. At this point the reaction is stopped by adding 36 g of formic acid of 85% concentration. The reaction mixture is then cooled to 40° C. and filtered. There are obtained 533 g of a 30% solution (W_{P6}) of product (P6).

### EXAMPLE 7

26.92 g of glycerol are heated to 80° C. and 0.2 g of boron trifluoride etherate are added with stirring. To this mixture 73.08 g of epichlorohydrin are added over 2 hours while maintaining the temperature at 80-85° C. with cooling. Stirring is continued for one further hour at 80° C. and then 80 g of water are added, by which the temperature drops to 50° C. 85 g of diethylenetriamine are added over two hours maintaining the temperature of the reaction mixture at 80° C. Stirring is continued at this temperature until the reaction mixture begins to thicken. 80 g of water are added and stirring is continued at 80° C. until the reaction mixture begins to thicken again. 100 g of water are added and stirring is continued at 80° C. until the reaction mixture begins to thicken again. 111.6 g of water are added and stirring is continued at 80° C. until the chloride ion content reaches 1.35 mol/kg. At this point the reaction is stopped by adding 60 g of formic acid of 85% concentration. The reaction mixture is then cooled to 40° C. and filtered. There are obtained 616 g of a 30% solution (W_{P7}) of product (P7).

### EXAMPLE 8

26.92 g of glycerol are heated to 80° C. and 0.2 g of boron trifluoride etherate are added with stirring. To this mixture 73.08 g of epichlorohydrin are added over 2 hours while maintaining the temperature at 80-85° C. with cooling. Stirring is continued for one further hour at 80° C. and then the temperature is lowered to 50° C. A solution of 20 g of diethylenetriamine and 50 g of hexamethylenediamine in 80 g of water is added over two hours maintaining the temperature of the reaction mixture at 70° C. Stirring is continued at 80° C. until the reaction mixture begins to thicken. 281 g of water are added and stirring is continued at 60° C. until the chloride ion content reaches 1.28 mol/kg. At this point the reaction is stopped by adding 36 g of formic acid of 85% concentration. The reaction mixture is then cooled to 40° C. and filtered. There are obtained 567 g of a 30% solution (W_{P8}) of product (P8).

### EXAMPLE 9

25.12 g of ethylene glycol are heated to 70° C. and 0.2 g of boron trifluoride etherate are added with stirring. To this mixture 74.88 g of epichlorohydrin are added over 2 hours while maintaining the temperature at 80-85° C. with cooling. Stirring is continued for one further hour at 80° C. and then 80 g of water are added, by which the temperature drops to 50° C. 50 g of diethylenetriamine are added over two hours maintaining the temperature of the reaction mixture at 80° C. Stirring is continued at this temperature until the chloride ion content reaches 2.60 mol/kg. At this point 236 g of water are added and the reaction is stopped by adding 36 g of formic acid of 85% concentration. The reaction mixture is then cooled to 40° C. and filtered. There are obtained 502 g of a 30% solution (W_{P9}) of product (P9).

### EXAMPLE 10

A mixture of 25.14 g of sorbitol and 12.74 g of glycerol is heated to 80° C. and 0.15 g of boron trifluoride etherate are added with stirring. To this mixture 75.45 g of epichlorohydrin are added over 2 hours while maintaining the temperature at 85-95° C. with cooling. Stirring is continued for one further hour at 80° C. and then 80 g of water are added, by which the temperature drops to 50° C. 50.7 g of diethylenetriamine are added over two hours maintaining the temperature of the reaction mixture at 60° C. Stirring is continued at this temperature until the chloride ion content reaches 2.12 mol/kg. At this point 268 g of water are added and the reaction is stopped by adding 33 g of formic acid of 85% concentration. The reaction mixture is then cooled to 40° C. and filtered. There are obtained 545 g of a 30% solution (W_{P10}) of product (P10).

### EXAMPLE 11

40.38 g of glycerol are heated to 80° C. and 0.3 g of boron trifluoride etherate are added with stirring. To this mixture 109.62 g of epichlorohydrin are added over 2 hours while maintaining the temperature at 80-85° C. with cooling. Stirring is continued for one further hour at 80° C. and then 50 g of water are added, by which the temperature drops to 60° C. 194.4 g of water are then added over two hours at 60° C. At this temperature a mixture of 31.2 g of diethylenetriamine and 31.5 g of N,N-dimethylaminopropylamine is added over two hours maintaining the temperature of the reaction mixture at 60° C. Stirring is continued at this temperature for one hour, then the mixture is cooled to 30° C. and 151.4 g of an aqueous 32% sodium hydroxide solution is added over 10 minutes. Stirring is continued for 17 hours until the chloride ion content reaches 1.55 mol/kg. At this point the reaction is stopped by adding 100.5 g of formic acid of 85% concentration. The reaction mixture is then cooled to 40° C. and filtered. There are obtained 709 g of a 30% solution (W_{P11}) of product (P11).

### EXAMPLE 12

In a first reactor 21.11 g of ethylene glycol are heated to 70° C. and 0.2 g of boron trifluoride etherate are added with stirring. To this mixture 78.69 g of epichlorohydrin are added over 2 hours while maintaining the temperature at 80-85° C. and stirring is continued for one further hour at 80° C. to give the corresponding chlorohydrin.

80 g of water and 71.54 g of triethylenetetraamine are charged in a second reactor. The temperature is maintained at 50-55° C. The chlorohydrin produced in the first reactor is added over two hours to this mixture maintaining the temperature of the reaction mixture at 50-55° C. The mixture is then heated to 80° C. and stirring is continued at this temperature until the reaction mixture begins to thicken. 80 g of water are added and stirring is continued at 80° C. until the chloride ion content reaches 2.30 mol/kg. 185.4 g of water are added and the reaction is stopped by adding 54.9 g of formic acid of 85% concentration. The reaction mixture is then cooled to 40° C. and filtered. There are obtained 571 g of a 30% solution (W_{P12}) of product (p12).

### APPLICATION EXAMPLE A

100 parts of cotton fabric, which have been dyed by an exhaust method with C.I. Reactive Yellow 27 to 1/1 standard depth, soaped and rinsed, are aftertreated at a liquor-to-goods ratio of 10:1 with an aqueous treatment bath with 3% of Composition (W_{P1}) of Example 1 at pH 7 by first giving 1000 parts of demineralised water at 40° C. into the vessel and then adding the 3 parts of Composition (W_{P1}) of Example 1 over 5 minutes thereto and carrying on exhaustion for 15 minutes at 40° C. by continuously running the movement of the cloth. Then the bath is drained and the goods are rinsed in a fresh bath. There is obtained a yellow dyeing with improved fastness to chlorine over the non-aftertreated dyeing, while shade and brilliance of the dyeing and handle of the dyed cloth are unaltered.

### APPLICATION EXAMPLES B, C AND D

The procedure described in Application Example A is repeated, with the difference that the 100 parts of cotton fabric have been dyed by an exhaust method with C.I. Reactive Yellow 186, Colour Index Reactive Blue 19 or Colour Index Reactive Blue 21 respectively to 1/1 standard depth in each case. There are obtained yellow or blue dyeings with improved fastness to chlorine over the non-aftertreated dyeing, while shade and brilliance of the dyeings and handle of the dyed cloths are unaltered.

### APPLICATION EXAMPLE E

A cotton fabric is dyed by an exhaust method with C.I. Reactive Red 241 to 1/1 standard depth, washed off, rinsed and dried. It is then padded with an aqueous padding liquor containing 30 g/l of Composition (W_{P1}) of Example 1 to a pick-up of 80% and then dried in hot air at 120° C. There is obtained a red dyeing with improved fastness to chlorine over the non-aftertreated dyeing, while shade and brilliance of the dyeing and handle of the dyed cloth are unaltered.

### APPLICATION EXAMPLE F

A polyamide 6 fabric dyed by an exhaust method with C.I. Acid Violet 48 to 1/1 standard depth is rinsed and dried. It is then padded with an aqueous padding liquor containing 30 g/l of Composition (W_{P1}) of Example 1 to a pick-up of 80% and then dried in hot air at 120° C. There is obtained a violet dyeing with improved fastness to chlorine over the non-aftertreated dyeing, while shade and brilliance of the dyeing are unaltered.

### APPLICATION EXAMPLES G, H AND J

The procedure described in Application Example F is repeated, with the difference that the polyamide fabric has been dyed by an exhaust method with C.I. Acid Yellow 184, C.I. Acid Red 336 or C.I. Acid Blue 350 respectively to 1/1 standard depth in each case. There are obtained yellow, red or blue dyeings with improved fastness to chlorine over the non-aftertreated dyeing, while shade and brilliance of the dyeings are unaltered.

### APPLICATION EXAMPLE L

A polyamide 6 fabric dyed by an exhaust method with C.I. Acid Violet 48 to 1/3 standard depth is rinsed and dried. It is then padded with an aqueous padding liquor containing 40 g/l of Composition (W_{P1}) of Example 1 to a pick-up of 80% and then dried in hot air at 120° C. There is obtained a light violet dyeing with improved fastness to chlorine over the non-aftertreated dyeing, while shade and brilliance of the dyeing are unaltered.

### APPLICATION EXAMPLE M

A cotton fabric dyed by an exhaust method with C.I. Direct Red 80 to 1/1 standard depth is well rinsed and dried. It is then padded with a padding solution containing 30 g/l of Composition (W_{P1}) of Example 1 to a pick-up of 80% and dried in hot air at 120° C. There is obtained a red dyeing with improved fastness to chlorine over the non-aftertreated dyeing, while the handle of the dyed cloth is unaltered.

### APPLICATION EXAMPLE N

A cotton fabric dyed by an exhaust method with C.I. Leuco Sulphur Black 1 to standard black depth is well rinsed after the usual oxidation and dried. It is then padded with a padding solution containing 30 g/l of Composition (W_{P1}) of Example 1, squeezed to a pick-up of 80% and dried in hot air at 120° C. There is obtained a black dyeing with improved fastness to chlorine over the non-aftertreated dyeing, while shade and handle of the dyed cloth are unaltered.

### APPLICATION EXAMPLE O

A cotton fabric dyed by an exhaust method with C.I. Direct Yellow 162 to 1/1 standard depth is well rinsed and aftertreated at a liquor to goods ratio of 10:1 with an aqueous treatment bath containing 3 g/l of Composition (W_{P1}) of Example 1 at 40° C. for 20 minutes. Then the bath is drained and the goods are rinsed in a fresh bath. The bath is drained and the goods are discharged and dried. There is obtained a yellow dyeing with improved fastness to chlorine over the non-aftertreated dyeing, while shade, brilliance and handle of the dyed cloth are unaltered.

Analogously as the product (P1) of Example 1 in the form of its Composition (W_{P1}), the products (P2) to (P12) of Examples 2-12 are employed in the form of their Compositions (W_{P2}) to (W_{P12}) in Application Examples A to O, giving also improved results.

### APPLICATION EXAMPLE P

100 parts of cotton fabric, which have been dyed by an exhaust method with C.I. Reactive Blue 21 to 1/3 standard depth, soaped and rinsed, are aftertreated at a liquor-to-goods ratio of 10:1 with an aqueous treatment bath with 3% of Composition (W_{P12}) of Example 12 at pH 7 by first giving 1000 parts of demineralised water at 40° C. into the vessel and then adding the 3 parts of Composition (W_{P12}) of Example 12 over 5 minutes thereto and carrying on exhaustion for 20 minutes at 40° C. by continuously running the movement of the goods. Then the bath is drained and the goods are rinsed in a fresh water bath. There is obtained a turquoise dyeing with improved fastness to chlorine over the non-aftertreated dyeing, while shade and brilliance of the dyeing and handle of the dyed cloth are unaltered.

Analogously as the product (P12) of Example 12 in the form of its Composition (W_{P12}), the products (P1) to (P11) of Examples 1-11 are employed in the form of their Compositions (W_{P1}) to (W_{P11}) in Application Example P, giving also improved results.

1. A method for aftertreatment of a dyed or printed textile fibrous material (T_{F}) dyed or printed with at least one water soluble dye (F), comprising the step of contacting the dyed or printed textile fibrous material (T_{F}) with a polymeric etheramine (P) obtained by condensation reaction of a chloroterminated adduct (E) of
(A) an oligohydroxycompound with x hydroxy groups per molecule linked to a hydrocarbon radical optionally interrupted by oxygen, wherein x is a number in the range of 2 to 6, or a mixture thereof,
(B) epichlorohydrin, in the ratio of m moles of epichlorohydrin for every mole of oligohydroxycompound or a mixture thereof wherein m is ≧2 and less than or equal to 1.2*x,
(C) at least one amino compound containing in its basic form at least two reactive hydrogen atoms bonded to nitrogen and no tertiary amino groups, and optionally
(D) at least one aliphatic secondary monoamine, at least one aliphatic diamine containing a primary or secondary amino group and a tertiary amino group or a mixture thereof,
or dehydrochlorination reaction of (E) to the corresponding epoxide (E_{X}) and reaction of (E_{X}) with (C) and optionally (D).

2. The method according to claim 1, wherein the adduct (E) or the corresponding epoxide (E_{X}) is reacted with (C) and optionally (D), in the ratio of n moles of (C) and p moles of (D) for every mole of the adduct (E) or the corresponding epoxide (E_{X}), wherein n is a number >0.4·m and <m, p is a number ≧0 and n+p<m.

3. The method according to claim 1, wherein
(A) is selected from the group consisting of:
(A₁) an oligohydroxyalkane of molecular weight ≧92 and with x1 hydroxy groups, wherein x1 is a number in the range of 3 to 6, or a mixture thereof,
(A₂) an alkanediol containing 2 to 6 carbon atoms or an oligoalkyleneglycol wherein the alkylene contains 2 or 3 carbon atoms or a mixture thereof,
and a mixture of one or more of (A₁) with at least one (A₂),
(C) is selected from the group consisting of:
(C′) at least one monoamino compound selected from the group consisting of
(C₁) ammonia,
and (C₂) at least one aliphatic primary monoamine,
and (C″) at least one oligoamine selected from the group consisting of
(C₃) at least one aliphatic diamine containing two secondary amino groups and no further amino groups,
and (C₄) at least one aliphatic oligoamine containing at least one primary amino group and at least one further amino group which is primary or secondary.

4. The method according to claim 3, wherein (C) is
(C₄′) at least one amino compound of formula (III) 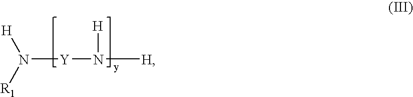
wherein R₁ is hydrogen or C₁₋₃-alkyl,
y is a number from 1 to 3
and Y is C₂₋₃-alkylene, if y is 2 or 3,
or is C₂₋₆-alkylene, if y is 1,
and (D) is at least one amino compound of formula (IV) 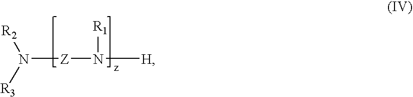
wherein Z is C₂₋₆-alkylene,
z is 0 or 1,
R₂ is C₁₋₃-alkyl
and R₃ is C₁₋₃-alkyl.

5. The method according to claim 4, wherein (P) is a reaction product of (E) or (E_{X}) with (C₄′), wherein (A) is a compound of formula
X₀—(OH)ₓ (I′),
wherein X₀ is the x-valent radical of a saturated aliphatic hydrocarbon with 2 to 6 carbon atoms
and x is a number in the range of 2 to 6 and is ≦ the number of carbon atoms in X₀,
or a mixture thereof,
and (C₄′) is a compound of formula (III), wherein R₁ is hydrogen or methyl and Y is ethylene, propylene or hexamethylene, or a mixture thereof.

6. The method according to claim 5, wherein (A) is selected from the group consisting of:
(A₁₁) at least one compound of formula
H—(CHOH)ₓ₁—H (Ia′),
wherein x1 is a number in the range of 3 to 6,
at least one alkanediol (A₂₁′) of formula
HO—X₃′—OH (Ic′),
wherein X₃′ is C₂₋₄-alkylene,
and mixtures of one or more thereof.

7. The method according to claim 6, wherein
(A) is selected from the group consisting of: glycerol, sorbitol, ethylene glycol, propylene glycol and mixtures thereof,
and (C₄′) is selected from the group consisting of: ethylenediamine, diethylenetriamine, triethylenetetraamine, hexamethylenediamine and mixtures thereof.

8. (canceled)

9. A process according to claim 1, wherein (P) is an aqueous composition (W_{P}).

10. A process according to claim 1, wherein the fibrous material (T_{F}) has been dyed with (F) by an exhaust or impregnation process or has been printed with (F), and aftertreatment with (P) is carried out by exhaustion or by impregnation.

11. A process according to claim 1, wherein the fibrous material (T_{F}) has a high affinity for basic dyes, has been dyed with (F) by an exhaustion method, and is aftertreated with (P) by exhaustion.

12. A process according to claim 1, further comprising the step of fixating the at least one water soluble dye (F) on the fibrous material (T_{F}) with a fixing agent (X) other than (P) is carried out.

13. A process according to claim 12, wherein (X) is a cationic fixative (X′) or an anionic fixative (X″).

14. A process according to claim 13, wherein the cationic fixative (X′) is employed before, subsequently to or in admixture with the polymeric etheramine (P).

15. A process according to claim 14, wherein the dyed or printed textile fibrous material (T_{F}) is aftertreated with a mixture (M_{PX}) of the polymeric etheramine (P) with the cationic fixative (X′).

16. A mixture (M_{PX}) of the cationic fixative (X′) with the polymeric etheramine (P) obtained by condensation reaction of a chloroterminated adduct (E) of
(A) an oligohydroxycompound with x hydroxy groups per molecule linked to a hydrocarbon radical optionally interrupted by oxygen, wherein x is a number in the range of 2 to 6,
or a mixture thereof,
(B) epichlorohydrin, in the ratio of m moles of epichlorohydrin for every mole of oligohydroxycompound or a mixture thereof wherein m is ≧2 and less than or equal to 1.2*x,
(C) at least one amino compound containing in its basic form at least two reactive hydrogen atoms bonded to nitrogen and no tertiary amino groups, and optionally
(D) at least one aliphatic secondary monoamine, at least one aliphatic diamine containing a primary or secondary amino group and a tertiary amino group or a mixture thereof,
or dehydrochlorination reaction of (E) to the corresponding epoxide (E_{X}) and reaction of (E_{X}) with (C) and optionally (D).

17. An aqueous composition (W_{PX}) comprising a mixture (M_{PX}) according to claim 16.

18. A dyed or printed fibrous textile substrate aftertreated in accordance with the method of claim 1.

19. A process for producing a mixture of a cationic fixative (X′) with a polymeric etheramine (P) comprising the steps of
providing a vessel,
reacting via a condensation reaction
(A) an oligohydroxycompound with x hydroxy groups per molecule linked to a hydrocarbon radical optionally interrupted by oxygen, wherein x is a number in the range of 2 to 6,
or a mixture thereof,
(B) epichlorohydrin, in the ratio of m moles of epichlorohydrin for every mole of oligohydroxycompound or a mixture thereof wherein m is ≧2 and less than or equal to 1.2*x,
(C) at least one amino compound containing in its basic form at least two reactive hydrogen atoms bonded to nitrogen and no tertiary amino groups,
and optionally
(D) at least one aliphatic secondary monoamine, at least one aliphatic diamine containing a primary or secondary amino group and a tertiary amino group or a mixture thereof,
or reacting via a dehydrochlorination reaction of (E) to the corresponding epoxide (E_{X}) and reaction of (E_{X}) with (C) and optionally (D) followed by adding a cationic fixative (X′) to the vessel.

20. The mixture produced in accordance with claim 19.
